(19) United States
(12) Patent Application Publication
(10) Pub. No.: US 2014/0097369 A1
(43) Pub. Date: Apr. 10, 2014

(54) SOLENOID VALVE FOR BRAKE SYSTEM

(71) Applicant: MANDO CORPORATION, Pyeongtaek-si (KR)

(72) Inventor: Ju Sung LEE, Yongin-si (KR)

(73) Assignee: MANDO CORPORATION, Pyeongtaek-si (KR)

(21) Appl. No.: 14/049,473

(22) Filed: Oct. 9, 2013

(30) Foreign Application Priority Data
Oct. 9, 2012 (KR) 10-2012-0111706

(51) Int. Cl. F16K 31/06

(52) U.S. Cl. CPC F16K 31/0658
USPC 251/129.15

(57) ABSTRACT

A solenoid valve for a brake system includes a seat housing installed in a bore of a modulator block and provided with a through hole formed therethrough in a longitudinal direction, a valve seat installed in the through hole of the seat housing and provided with an orifice, a sleeve provided with a hollow formed therein and connected to the seat housing to surround an outer surface of an upper portion of the seat housing, a magnetic core to seal an upper portion of the sleeve, an armature installed in the sleeve to be movable forward and backward, and a return spring installed in the sleeve to press the armature toward the valve seat. A spring seating groove to accommodate the return spring is formed at an upper portion of the armature, and a through hole penetrating the armature is formed to communicate with the spring seating groove.

### CROSS-REFERENCE TO RELATED APPLICATION(S)

This application claims the benefit of Korean Patent Application No. 2012-0111706, filed on Oct. 9, 2012 in the Korean Intellectual Property Office, the disclosure of which is incorporated herein by reference.

### BACKGROUND

1. Field

Embodiments of the present invention relate to a solenoid valve for a brake system which facilitates discharge of air from the solenoid valve, improving control performance of the solenoid valve.

2. Description of the Related Art

In general, a hydraulic brake of a vehicle performs braking by applying hydraulic pressure to a master cylinder according to operation of a brake pedal. When braking force applied to the tires exceeds static frictional force between a road surface and the tires, slippage of tires on the road surface may occur.

However, a coefficient of kinetic friction is less than a coefficient of static friction, and thus in order to achieve optimal braking, such slippage needs to be prevented, and steering wheel lock, a phenomenon in which steering wheel control is lost during heavy braking, also needs to be prevented.

Therefore, an anti-lock brake system (ABS), which controls hydraulic pressure applied to a master cylinder to prevent tire slippage, has been proposed. The ABS basically includes a plurality of solenoid valves, an electronic control unit (ECU) to control the solenoid valves, an accumulator and a hydraulic pump.

These solenoid valves are classified into a Normally Open type, the valves of which are disposed upstream of the hydraulic brake and kept open at normal times, and a Normally Closed type, the valves of which are disposed downstream of the hydraulic brake and kept closed at normal times.

FIG. 1 is a view illustrating a conventional solenoid valve of the Normally Closed type. This valve is press-fitted into a bore 15 of a modulator block 11 provided with fluid passages of a brake system, and includes a hollow seat housing 1 having an inlet 3 and an outlet 4 respectively communicating with an inflow passage 13 and an outflow passage 14 of the modulator block 11 to allow fluid flow.

The seat housing 1 is hollowed inside to communicate with the inlet 3 and the outlet 4. A valve seat 8 having an orifice 8a formed at an upper portion thereof is press-fitted into the seat housing 1.

In addition, a cylindrical sleeve 6 is connected to the seat housing 1 at the upper side of the seat housing 1 to allow an armature 5 installed in the seat housing 1 to move forward and backward. A magnetic core 7 is connected to an open end of the sleeve 6 to close the open end of the sleeve 6 and cause the armature 5 to move forward and backward.

The armature 5, which is formed of a magnetic material, opens and closes the orifice 8a of the valve seat 8 installed in the seat housing 1 through forward and backward movement thereof. To this end, the armature 5 is provided with an opening and closing part 5a extending toward the valve seat 8 through a hollowed through hole 2 of the seat housing 1.

A return spring 9 to press the armature 5 is installed between the armature 5 and the magnetic core 7 so that the orifice 8a is closed by the armature 5 at normal times, and an exciting coil assembly (not shown) to move the armature 5 forward and backward is installed at outer sides of the sleeve 6 and the magnetic core 7.

To improve the performance of the solenoid valve 10 and reduce noise, ejection of air remaining in the solenoid valve 10 is performed when the solenoid valve 10 is installed, such that no air is present in the solenoid valve 10. In addition, to ensure smooth operation of the solenoid valve 10, brake oil is injected into the solenoid valve 10.

However, as shown in FIG. 1, since a spring seating groove 5b is formed at the upper portion of the armature 5 to ensure stable installation of the return spring 9 to apply pressure to the armature 5, air present in the spring seating groove 5b may not be discharged. Thereby, air may remain in the solenoid valve 10, and thus vibration and noise may be produced during operation of the solenoid valve 10.

### SUMMARY

Therefore, it is an aspect of the present invention to provide a solenoid valve for a brake system which has a through hole for discharge of air in an armature, thereby allowing smooth discharge of air from the solenoid valve to prevent vibration and noise during operation of the solenoid valve.

Additional aspects of the invention will be set forth in part in the description which follows and, in part, will be obvious from the description, or may be learned from practice of the invention.

In accordance with one aspect of the present invention, a solenoid valve for a brake system includes a seat housing installed in a bore of a modulator block and provided with a through hole formed therethrough in a longitudinal direction, a valve seat installed in the through hole of the seat housing and provided with an orifice, a sleeve provided with a hollow formed therein and connected to the seat housing to surround an outer surface of an upper portion of the seat housing, a magnetic core to seal an upper portion of the sleeve, an armature installed in the sleeve to be movable forward and backward, and a return spring installed in the sleeve to press the armature toward the valve seat, wherein a spring seating groove to accommodate the return spring is formed at an upper portion of the armature, and a through hole penetrating the armature is formed to communicate with the spring seating groove.

The through hole may be formed to penetrate the outer circumferential surface of the armature.

The through hole may be penetrated to be connected to the spring seating groove on a bottom surface of the spring seating groove.

The through hole may be spaced apart from an oil passage formed on an outer surface of the armature along a longitudinal direction of the armature.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a cross-sectional view illustrating a conventional solenoid valve;

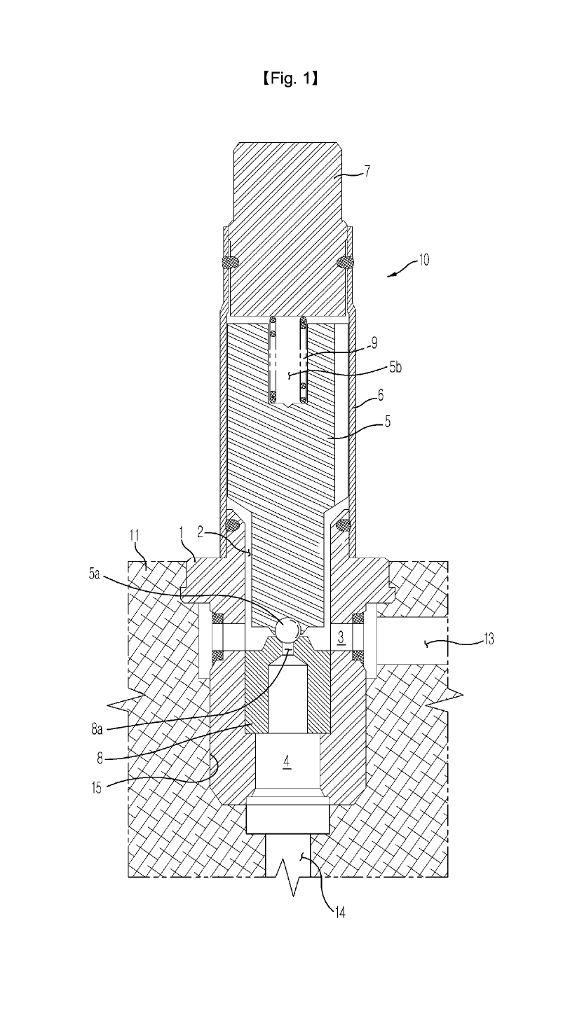

FIG. 2 is a cross-sectional view illustrating a solenoid valve for a brake system in accordance with an exemplary embodiment of the present invention; and

FIG. 3 is a cross-sectional view illustrating a solenoid valve for a brake system in accordance with another embodiment of the present invention.

FIG. 4 is a cross-sectional view illustrating a solenoid valve for a brake system in accordance with still another embodiment of the present invention.

### DETAILED DESCRIPTION

Reference will now be made in detail to the embodiments of the present invention, examples of which are illustrated in the accompanying drawings, wherein like reference numerals refer to like elements throughout.

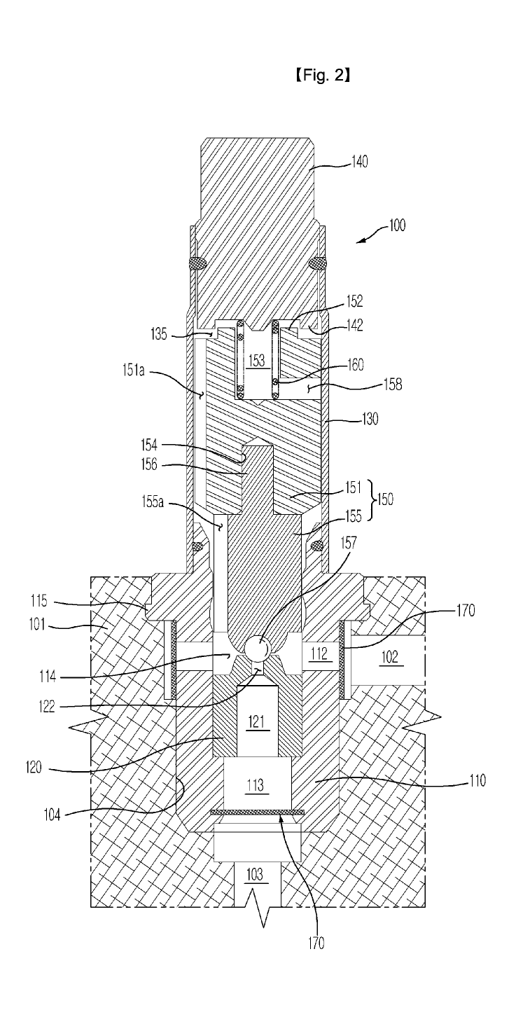

FIG. 2 is a cross-sectional view illustrating a solenoid valve for a brake system in accordance with an exemplary embodiment of the present invention.

Referring to FIG. 2, a solenoid valve 100 for a brake system includes a seat housing 110 inserted into a modulator block 101, a valve seat 120 installed in the seat housing 110, a sleeve 130 connected at one end to the seat housing 110, a magnetic core 140 connected to the other end of the sleeve 130 opposite to the seat housing 110, an armature 150 moving forward and backward within the sleeve 130, and a return spring 160 installed in the sleeve 130.

The seat housing 110 has a cylindrical shape, and is provided with a through hole 114 formed through the center thereof in the longitudinal direction. Provided on the outer surface of the seat housing 110 is a flange 115 to fix the seat housing 110 to an inlet of a bore 104 of the modulator block 101. The flange 115 is fixed by deformation of the modulator block 101 when the valve 100 is installed.

The seat housing 110 is further provided with an inflow port 112 and an outflow port 113 respectively communicating with an inflow passage 102 and an outflow passage 103 formed in the modulator block 101 through which oil is introduced into and discharged from the seat housing 110, in addition to the through hole 114.

The valve seat 120 is press-fitted into the through hole 114 of the seat housing 110 and fixed. The valve seat 120 is provided with an inner passage 121 penetrating the valve seat 120 in the longitudinal direction and an orifice 122 formed at an upper portion of the inner passage 121 to open and close the inner passage 121.

The sleeve 130 has a cylindrical shape such that the armature 150 installed in a hollow 135 of the sleeve 130 may move forward and backward, and upper and lower portions of the sleeve 130 are open. The open lower portion of the sleeve 130 is press-fitted to the outer surface of the upper portion of the seat housing 110. The sleeve 130 may be fixed to the seat housing 110 through welding, etc.

Connected to the open upper portion of the sleeve 130 is a magnetic core 140 which closes the open upper portion of the sleeve 130 and generates electromagnetic force to move the armature 150 forward and backward. To generate electromagnetic force, an exciting coil assembly (not shown) to generate a magnetic field according to application of power is installed on the outer sides of the magnetic core 140 and the sleeve 130. When power is applied to the exciting coil assembly, the armature 150 moves toward the magnetic core 140.

A return spring 160 is installed between the armature 150 and the magnetic core 140 such that the armature 150 is returned to an original position thereof to close the orifice 122 of the valve seat 120 when electric power applied to the exciting coil assembly is interrupted.

The return spring 160 is inserted into a spring seating groove 153 formed at an upper portion of the armature 150 to press the armature 150.

According to one embodiment of the present invention, the armature 150 opens and closes the orifice 122 of the valve seat 120 by through forward and backward movement thereof, as described above. More specifically, the armature 150 includes an upper armature 151 arranged in the sleeve 130 to move forward and backward, and a lower armature 155 inserted into the through hole 114 of the seat housing 110 to move forward and backward.

The upper armature 151 is formed of a magnetic material, and has an outer diameter corresponding to the inner diameter of the sleeve 130 so as to be guided within the hollow 135 of the sleeve 130.

The lower armature 155 is formed of a non-magnetic material and guided within the seat housing 110 to move forward and backward. A spherical opening and closing part 157 is provided at the lower end of the lower armature 155 to open and close the orifice 122. In addition, slot-shaped oil passages 151a and 155a are formed at the outer surfaces of the upper and lower armature 151 and 155 to allow oil to flow therethrough in the vertical longitudinal direction such that the armature 150 moves smoothly.

As the lower armature 155 is formed of a non-magnetic material, degradation of responsiveness of the solenoid valve 100 that may be caused by the narrowed gap between the lower armature 155 and the seat housing 110 may be avoided.

Additionally, the lower armature 155 is press-fitted into the upper armature 151 to move together with the upper armature 151. That is, as shown in FIG. 2, a coupling groove 154 is provided on the lower surface of the upper armature 151 by grooving a portion of the lower surface of the upper armature 151 in the longitudinal direction, and a coupling protrusion 156 is provided on the upper surface of the lower armature 155 to extend from the upper surface of the lower armature 155 to be coupled with the coupling groove 154. As the coupling protrusion 156 is press-fitted into the coupling groove 154, the upper armature 151 and the lower armature 155 move simultaneously.

Further, symmetrical stepped parts 152 and 142 are respectively provided on the upper surface of the upper armature 151 and the lower surface of the magnetic core 140 to define a distance of forward and backward movement of the armature 150 when the armature 150 is moved by a magnetic field. That is, the stepped part 152 on the upper surface of the upper armature 151 and the stepped part 142 on the lower surface of the magnetic core 140 are formed to engage with each other.

According to this embodiment, the armature 150 configured as above is provided with a through hole 158 to smoothly discharge air from the spring seating groove 153 when the solenoid valve 100 is installed. Accordingly, the through hole 158 is formed to communicate with the spring seating groove 153. More specifically, referring to FIG. 2, the through hole 158 is formed to penetrate the outer circumferential surface of the armature 150, i.e., the upper armature 151. Herein, the through hole 158 is arranged perpendicular to the spring seating groove 153 and is connected to the spring seating groove 153 on the bottom surface of the spring seating groove 153. This is intended to cause smooth discharge of air from the spring seating groove 153. In addition, the through hole 158 is spaced apart from the oil passage 151 a formed on the outer surface of the upper armature 151 along the longitudinal direction of the upper armature 151, i.e., formed to face in a different direction.

While the through hole 158 formed in the armature 150 is illustrated as being arranged perpendicular to the spring seating groove 153, embodiments of the present invention are not limited thereto. The number and shape of the through holes 158 may be changed so long as air is easily discharged from the spring seating groove 153.

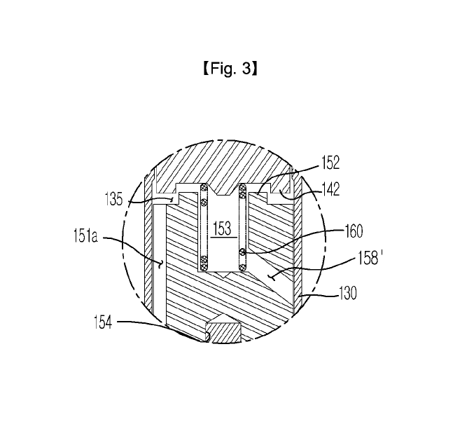

For example, as shown in FIG. 3, a through hole 158′ may be formed to be inclined with respect to the bottom surface of the spring seating groove 153.

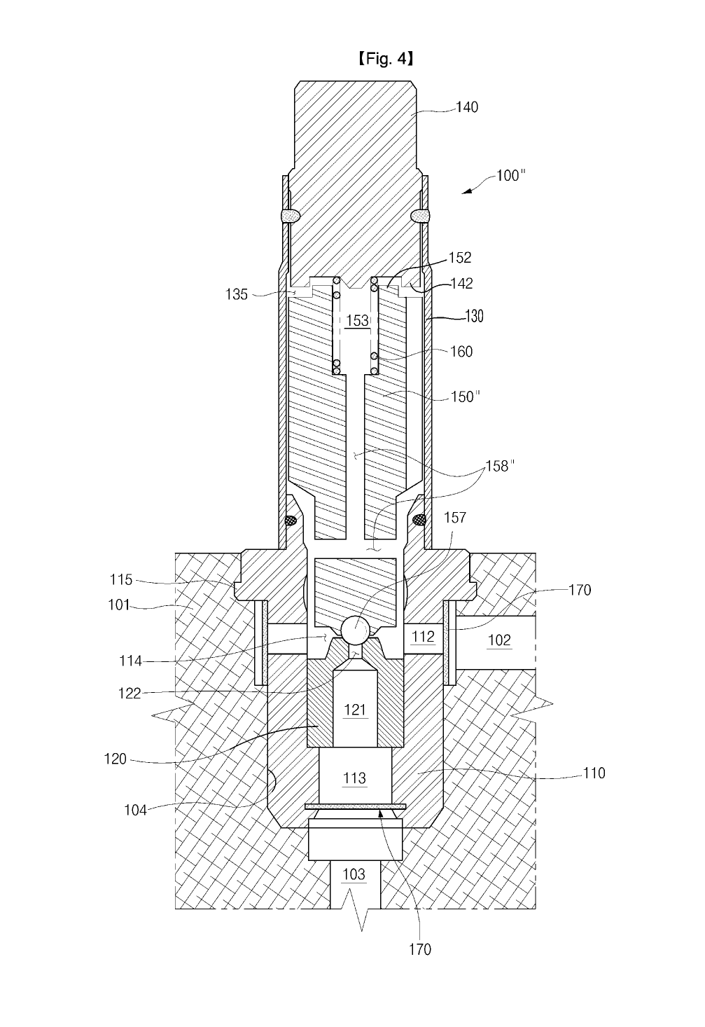

In addition, as shown in FIG. 4, a through hole 158″ may be formed to be in an inverse ‘T’ shape with respect to the bottom surface of the spring seating groove 153. That is, the through hole 158″ has a vertical through hole that is formed from the bottom surface of the spring seating groove 153 in a longitudinal direction of the spring seating groove 153, and a horizontal through hole that passes through from an outer surface of an armature 150″ so as to communicate with an end portion of the vertical through hole.

Meanwhile, when the through hole 158″ having an inverse T shape is formed, the armature 150″ in accordance with this embodiment is integrally formed as one unit without being separated into an upper portion and a lower portion thereof. That is, a solenoid valve for a brake system 100″ shown in FIG. 4 has the same configuration as the above embodiment except for the structure of the armature 150″ and the through hole 158″ formed in the armature 150″, and the same reference numerals will be assigned to the elements according to the present embodiment identical to the elements according to the previous embodiment.

According to the present invention, filter members 170 are installed at the inflow port 112 and outflow port 113 of the seat housing 110 to filter out impurities from oil flowing into the inflow passage 102 and discharged to the outflow passage 103 of the modulator block 101. While the filter members 170 are illustrated as being installed at the inflow port 112 and outflow port 113 of the seat housing 110, embodiments or the present invention are not limited thereto. The filter member 170 may be selectively installed in the seat housing 110 to filter out impurities from oil flowing through the inflow passage 102 or outflow passage 103 of the modulator block 101.

As discussed above, the solenoid valve 100 for a brake system according to this embodiment is provided with the through holes 158 and 158′ formed to penetrate the upper armature 151 to communicate with the armature 150, i.e., the spring seating groove 153. Thereby, air in the spring seating groove 153 may be easily discharged by the through holes 158 and 158′ when the solenoid valve 100 is installed. Accordingly, air may not remain in the solenoid valve 100, and thus vibration and noise may not be produced during the operation of the solenoid valve. Therefore, performance of the solenoid valve may be improved and the process of injection of brake oil into the solenoid valve may be simplified

As is apparent from the above description, a solenoid valve for a brake system according to one embodiment of the present invention is provided with a through hole to communicate with a spring seating groove. Thereby, air present in the spring seating groove may be smoothly discharged. That is, as air is not allowed to remain in the solenoid valve, generation of noise and vibration may be prevented during the operation of the solenoid valve. Thereby, the solenoid valve may be stably operated.

In addition, when the solenoid valve is installed, the process of injection of brake oil into the solenoid valve may be simplified.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A solenoid valve for a brake system including a seat housing installed in a bore of a modulator block and provided with a through hole formed therethrough in a longitudinal direction, a valve seat installed in the through hole of the seat housing and provided with an orifice, a sleeve provided with a hollow formed therein and connected to the seat housing to surround an outer surface of an upper portion of the seat housing, a magnetic core to seal an upper portion of the sleeve, an armature installed in the sleeve to be movable forward and backward, and a return spring installed in the sleeve to press the armature toward the valve seat,
wherein a spring seating groove to accommodate the return spring is formed at an upper portion of the armature, and a through hole penetrating the armature is formed to communicate with the spring seating groove.

2. The solenoid valve according to claim 1, wherein the through hole is formed to penetrate the outer circumferential surface of the armature.

3. The solenoid valve according to claim 1, wherein the through hole is penetrated to be connected to the spring seating groove on a bottom surface of the spring seating groove.

4. The solenoid valve according to claim 1, wherein the through hole is spaced apart from an oil passage formed on an outer surface of the armature along a longitudinal direction of the armature.
